(19) United States
(12) Patent Application Publication
(10) Pub. No.: US 2006/0176526 A1
(43) Pub. Date: Aug. 10, 2006

(54) Method for calibration of a laser thermal halftone printer

(75) Inventor: Craig Iannazzi, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/052,351

(22) Filed: Feb. 7, 2005

(51) Int. Cl. H04N 1/46

(52) U.S. Cl. 358/504

(57) ABSTRACT

A method of calibrating a printing system is described herein. The method includes measuring media sensitometry at the manufacturing location using controlled test equipment and distributing data via web, mailing, or RFID chip, optimizing exposures of a test pattern, averaging multiple machine calibrations and factory distributed calibration data, adjusting the calibration curve using pivot points and measured media differences

### FIELD OF THE INVENTION

The present invention relates to a method for calibrating a laser thermal proofer and more specifically optimizing exposures for a calibration target, averaging multiple density and exposure calibrations, measuring media performance at the factory, distributing calibration data, calculation of a calibration curve without the requirement of printing a calibration target, imaging a target for density control charting, and adjusting calibration curves when well known control chart rules have been violated.

### BACKGROUND OF THE INVENTION

Color proofing is a process used by the printing industry to simulate proofs generated on a press run. By using color proofing the printing industry saves time and money simulating how the press will look before the costly press run is performed. The advantage of a color proof is that it is a representation of an ideal press run. The color proof should reflect exactly what the printing industry would like to see coming off a press. The press is continually adjusted to match the color of the proof. The color proof therefore needs to be precise color, reproducible from proofer to proofer, and pre-press shop to pre-press shop. Proofs that exhibit color variation are deemed unacceptable.

One commercially available image processing apparatus, which is depicted in commonly-assigned U.S. Pat. No. 5,428,371, is an image processing apparatus having half-tone color proofing capabilities. This image processing apparatus is arranged to form an intended image on a sheet of thermal print media by transferring dye from a sheet of dye donor material to the thermal print media by applying thermal energy to the dye donor material, to transfer dye to the thermal print media, thereby forming an intended image. This image processing apparatus is comprised generally of a material supply assembly or carousel, lathe bed scanning subsystem (which includes a lathe bed scanning frame, translation drive, translation stage member, printhead, and vacuum imaging drum), thermal print media, and dye donor material exit transports.

The operation of the image processing apparatus comprises feeding a sheet of thermal media from the media roll to the vacuum drum, partially wrapped around the drum, cut to length, then wrapped fully around the drum. A length of dye donor from a roll form is similarly transported to the drum, partially wrapped around the drum, cut to a desired length, then fully wrapped around the vacuum drum. The dye donor material is wrapped around the vacuum imaging drum, such that it is superposed in registration with the thermal print media. The translation drive, part of the scanning subsystem, traverses the printhead and translation stage member axially along the vacuum imaging drum in coordinated motion with the rotating vacuum imaging drum to produce the intended image on the thermal print media.

The printhead includes a plurality of laser diodes that are coupled to the printhead by fiber optic cables that can be individually modulated to supply energy to selected areas of the donor in accordance with an information signal. The printhead includes a plurality of optical fibers coupled to the laser diodes at one end and at the other end to a fiber optic array within the printhead. The printhead moves relative to the longitudinal axis of the vacuum imaging drum and dye is transferred to the thermal print media as the radiation, transferred from the laser diodes by the optical fibers to the printhead to the dye donor material, is converted to thermal energy in the dye donor material.

Color variation is typically a result of variation of the individual color density used to define the desired color. There are many factors that influence the variation of a color in a proof. Factors include but are not limited to environment variability, density calibration technique, optical noise, thermal media coating quality, densitometer measurement noise, lamination noise, and digital proofer focus errors.

Due to factors that cause density variation, calibration of density is required to achieve high levels of consistency between a requested or desired density and the average density on an imaged proof. Calibration to the average proof density is desired due to the fluctuation of density within a single proof. To be most color accurate across the entire proof the average density should closely match the requested density.

Some early digital proofers, such as U.S. Pat. No. 5,268,708 utilized a linear calibration model over a specified density range. Specifications for the output density range were developed from printing standards. The SWOP standard was the model used for the calibration range for U.S. Pat. No. 5,268,708.

Presses are capable of producing more than cyan, magenta, yellow, and black output colors. Often special colors are added to expand the color of a print. Colors from a press are limited to the various ink colors that can be mixed or created—a virtually endless assortment. Presses therefore had a much larger color gamut than proofers, which are limited by the color gamut produced by thermal dye.

With the introduction of U.S. Pat. No. 5,428,371, color gamuts were expanded using a concept named “Recipe Color.” The amount of usable density range was increased for each thermal dye donor. Multiple passes of the same bitmap used for a single color plane were imaged using different thermal dye donor material. This allowed for custom color creation, and with the introduction of a few special thermal dye donor material, the color range of a proof is extended to closely match the output of a printing press using many different inks.

Commonly-assigned copending U.S. patent application Ser. No. 10/649,462 offered improved data processing, an extended calibrated dynamic density range, and improved color calibration through the use of controlled polynomial modeling of density and exposure data. One draw back of U.S. patent application Ser. No. 10/649,462 is the time required to calibrate thermal media was increased over previous calibration models as more density points were required to image and use for modeling the extended color space.

One drawback of U.S. Pat. No. 5,428,371 is the fact that calibration is required for every thermal media roll change. Customers are requested to spend time and money on calibration for every unique thermal donor and thermal receiver lot. Often customers will calibrate based on a schedule, not based on roll change, therefore the imaging device accuracy is sacrificed.

A disadvantage of U.S. patent application Ser. No. 10/649,462 is that the exposures for the calibration target are the same and broad in scope for all machines to compensate for machine to machine exposure variation. This disadvantage creates density data points on the calibration target for some machines that are not useable for building an exposure calibration model, therefore the density data points are discarded thus lowering the accuracy of the calibration model.

A disadvantage of U.S. patent application Ser. No. 10/649,462 is that the thermal media density can drift after an exposure calibration curve has been created causing inaccuracies in the output density.

U.S. Pat. Nos. 5,229,585; 6,634,814; 6,099,178, and U.S. Patent Application Publication No. 2004/0184801 discuss including readable sensitometric data with customer media supplies to control calibration. Typically the sensitometric data is referred to as a reference exposure. The disadvantage of a reference exposure is that the system that creates a reference exposure may drift over time. Systems that use lookup tables to reference exposure patches will become inaccurate if the reference system drifts and cannot be restored to original operating conditions.

### SUMMARY OF THE INVENTION

Briefly summarized, according to one aspect of the present invention, a method for calibration for an imaging apparatus comprises optimizing exposures used for imaging a calibration target such that all density points are used in modeling density and exposure data, averaging multiple calibration curves to create an average calibration curve, measuring thermal media exposure performance difference from average thermal media exposure performance on a control imaging device, distributing exposure calibration data via electronic media or on an RFID chip, adjusting an exposure calibration curve for an imaging device based on control imaging device measured thermal exposure differences, and adjusting an average exposure calibration curve for an imaging device based on averaged control imaging device measured thermal exposure differences.

According to one embodiment a series of test patches covering the range of desired exposures are imaged in order using randomized exposure values. The randomized nature of the data points, the range of exposures the points cover, and the number of points are used in order to gain high accuracy with the presence of many noise sources. The calibration proof is designed to be scanned using a scanning densitometer allowing for polynomial interpolation between patches for precise location of the requested density. Exposures for desired densities can be calculated for future calibration targets based on an initial exposure calibration curve. Thermal print media can be calibrated and control charted on a control imaging device allowing the calculation of thermal media lot to lot exposure differences. Multiple exposure calibration curves can be collected with correlating data sets of thermal media exposure differences. Using an averaged calibration curve and thermal media exposure differences, the averaged calibration curve can be adjusted to accommodate changes in lot to lot variability of sensitometric performance for thermal media and eliminate the requirement of exposure calibration for every unique thermal media.

An advantage of the present invention is decreased calibration time.

An advantage of the present invention is the ability to create thermal media exposure calibration data using a control imaging device that will drift over time.

An advantage of the present invention is decreased material required for calibration.

An advantage of the current invention is to bypass thermal media exposure calibration for every roll change.

An advantage of the present invention is increased accuracy locating the average density request in noisy density regions.

An advantage of the present invention is an increase in the number of data points used in density and exposure modeling which correlates to an increase in density accuracy.

The invention and its objects and advantages will become more apparent in the detailed description of the preferred embodiment presented below.

### BRIEF DESCRIPTION OF THE DRAWINGS

FIG. 1 is a side view and vertical cross-section of an image processing apparatus usable with embodiments of the present invention.

FIG. 2 is a perspective view of the lathe bed scanning subsystem usable with embodiments of the present invention viewed from the rear of the image processing apparatus.

FIG. 3 is a schematic diagram of the method of the embodiments described herein.

FIG. 4 shows a representation of the test pattern with a set of randomized exposures.

FIG. 5 shows an example of the calibration curve.

FIG. 6 shows the data set formed for use in embodiments of the invention.

FIG. 7 shows an example of optimizing calibration exposures on a calibration target and the resulting densities.

FIG. 8 shows a factory control chart which monitors control imaging device exposures for a requested density level for control thermal media.

FIG. 9 shows calibrated exposure for different thermal media lots of one type of thermal media and the calibrated exposure difference for each thermal media lot from an average calibrated exposure for all thermal media lots.

FIG. 10 shows the process for calculating an exposure calibration curve using an initial exposure calibration curve and exposure adjustments at defined density levels.

FIG. 11 shows exposure calibration averaging for multiple thermal media lots.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

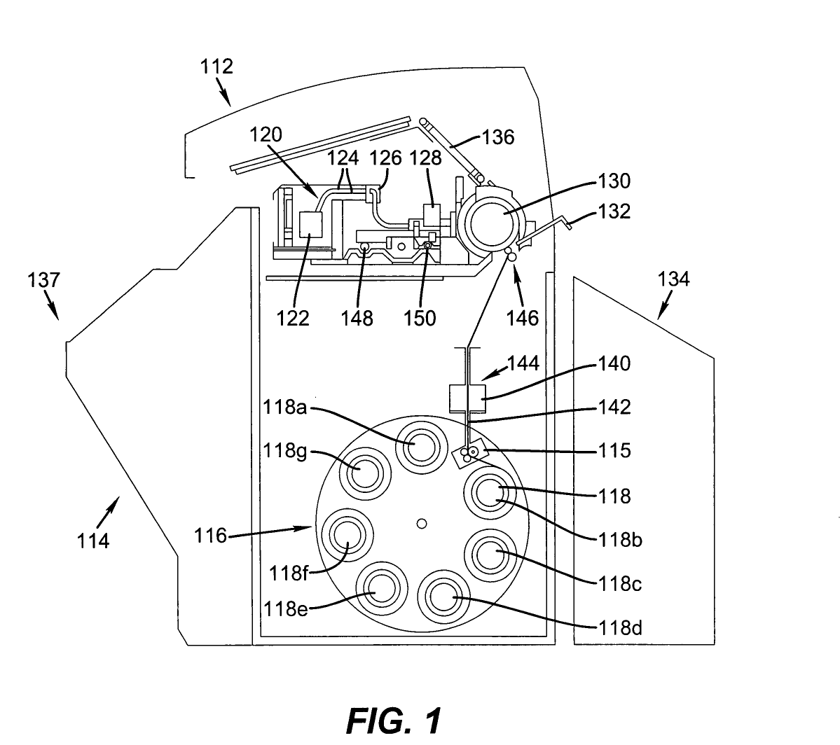

Referring to FIG. 1, there is illustrated an image processing apparatus according to the present invention having an image processor housing 112 which provides a protective cover. A movable, hinged image processor door 114 is attached to the front portion of image processor housing 112 permitting access to a media carousel 116. A roll of donor roll material 118a is connected to a media carousel 116 in a lower portion of image processor housing. Up to seven rolls of roll media can be used 118a, 118b, 118c, 118d, 118e, 118f and 118g. One roll of media 118g is thermal print media used to receive the donor material. This thermal print media 118g is passed to vacuum imaging drum 130 and is ultimately cut into donor sheet material (not shown). In this regard, a media drive mechanism 115 is attached to the thermal print media 118g, and includes three media drive rollers, two rollers 140 and 142 are shown in FIG. 1, through which the thermal print media of interest is metered upwardly into a media knife assembly 144. After thermal print media reaches drum load roller 146, media drive rollers 140, 142 cease driving the donor roll material and at least one media knife blade (not shown) positioned at the bottom portion of media knife assembly to cut the thermal print media roll into thermal print media sheets. Drum load roller 146 presses the cut thermal print media against the vacuum imaging drum 130 while the vacuum imaging drum 130 slowly rotates the cut media (not shown) around vacuum imaging drum 130.

Each remaining roll of donor material is a different color, typically black, yellow, magenta and cyan. Special colors include but are not limited to orange, green, blue, metallic, and white. These donor roll materials are passed to the vacuum imaging drum 130 and are ultimately cut into donor sheet materials (not shown) for forming the medium from which colorant imbedded therein are passed to thermal print media resting thereon, which process is described in detail below.

A media drive mechanism 115 is attached to each roll media of donor roll material, and includes three media drive rollers 112 through which the donor roll material 118a, 118b, 118c, 188d, and 188e of interest is metered upwardly into a media knife assembly 144. After donor roll material reaches drum load roller 146, media drive rollers 140, 142 cease driving the donor roll material and the media knife blade is positioned at the bottom portion of media knife assembly to cut the donor roll material into donor sheet materials. Drum load roller 146 presses the cut media against the vacuum imaging drum 130 while the vacuum imaging drum 130 slowly rotates the cut media (not shown) around vacuum imaging drum 130. The donor sheet material now rests atop the thermal print media (not shown) with a narrow space between the two created by microbeads embedded in the surface of the thermal print media.

A laser assembly 120 includes a quantity of laser diodes 122 in its interior. Laser diodes 122 are connected via fiber optic cables 124 to a distribution block 126 and ultimately to printhead 128. Printhead 128 directs thermal energy received from laser diodes 122 causing the donor sheet material to pass the desired colorant across the gap and onto the thermal print media (not shown).

In operation, vacuum imaging drum 130 rotates at a constant velocity. Printhead 128 begins at one end of the thermal print media and traverses the length of the thermal print media, transferring dye for a particular donor sheet material resting on the thermal print media. After printhead 128 has completed the transfer process, for the donor sheet material resting on the thermal print media the donor sheet material is then removed from the vacuum imaging drum 130 and transferred out of image processor housing 112 via a skive or donor ejection chute 132. The donor sheet material eventually comes to rest in a donor waste bin 134 for removal by the user. The process is then repeated for the other desired rolls of donor roll media.

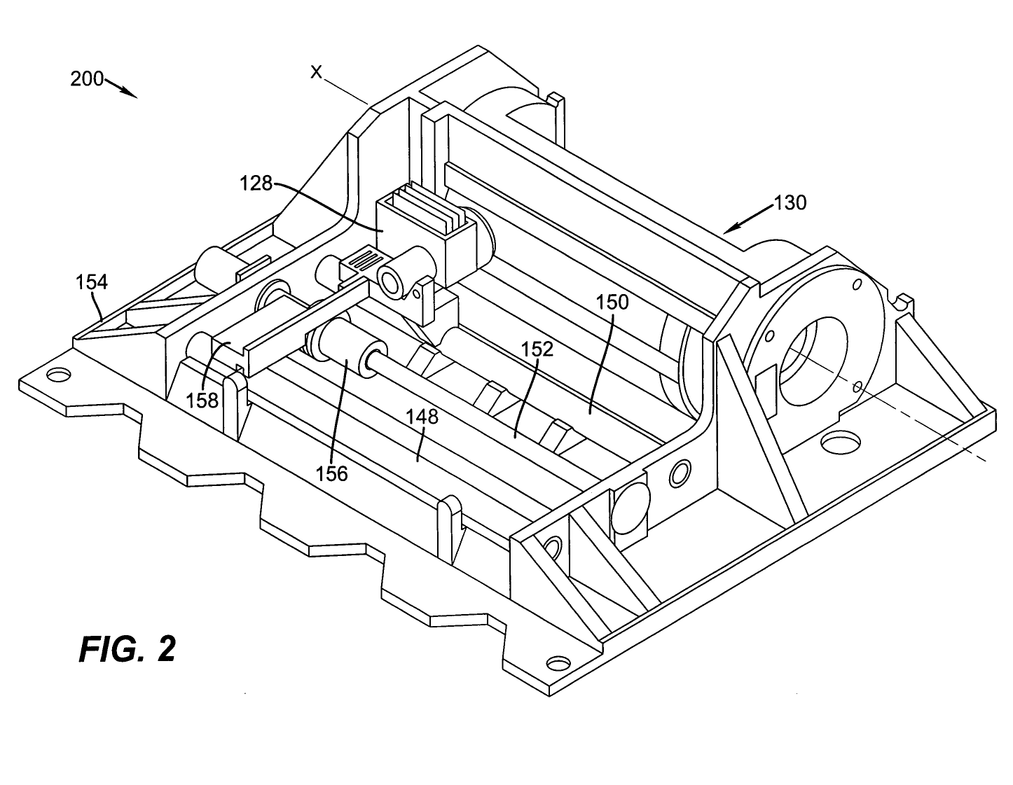

After the color from all desired sheets of the donor materials have been transferred and the donor sheet materials have been removed from vacuum imaging drum 130, the thermal print media is removed from vacuum imaging drum 130 and transported via a transport mechanism 136 to a exit tray 137. Thermal print media is then laminated to a paper stock using a 800XL laminator. FIG. 1 also show translation bearing rods 148, 150 which are explained with reference to FIG. 2.

FIG. 2 shows a perspective view of lathe bed scanning subsystem of image processing apparatus, including vacuum imaging drum 130, printhead 128, and lead screw 152 assembled in lathe bed scanning frame 154. Printhead 128 is attached to a lead screw 152 via a lead screw drive nut 156 and a drive coupling (not shown) for moving the printhead along the longitudinal axis of vacuum imaging drum 130 for transferring the dye to create the intended image onto the thermal print media 118g.

Vacuum imaging drum 130 is mounted for rotation about an axis X in lathe bed scanning frame 154. Printhead 128 is movable with respect to vacuum imaging drum 130, and is arranged to direct a beam of light to the donor sheet material. The beam of light from printhead 128 for each laser diode (not shown in FIG. 2) is modulated individually by modulated electronic signals from image processing apparatus, which are representative of the shape and color of the original image, so that the color on the donor sheet material is heated to cause volatilization only in those areas in which its presence is required on the thermal print media to reconstruct the shape and color of the original image.

Translation

Viewing FIGS. 1 and 2, printhead 128 is mounted on a movable translation stage member 158 which, in turn, is supported for low friction slidable movement on translation bearing rods 148 and 150. Translation bearing rods 148 and 150 are sufficiently rigid so as not to sag or distort as is possible between their mounting points and are arranged to be as parallel as possible with axis X of vacuum imaging drum 130 with the axis of printhead 128 perpendicular to the axis X of vacuum imaging drum 130. Front translation bearing rod 150 locates translation stage member 158 in the vertical and the horizontal directions with respect to axis X of vacuum imaging drum 130. Rear translation bearing rod 148 locates translation stage member 158 only with respect to rotation of translation stage member 158 about front translation bearing rod 150 so that there is no over-constraint condition of translation stage member 158 which might cause it to bind, chatter, or otherwise impart undesirable vibration or jitters to printhead 128 during the generation of an intended image.

Writing

Printhead 128 travels in a path along vacuum imaging drum 130, while being moved at a speed synchronous with the vacuum imaging drum 130 rotation and proportional to the width of a writing swath (not shown). The pattern that printhead 128 transfers to the thermal print media 118g along vacuum imaging drum 130 is a helix.

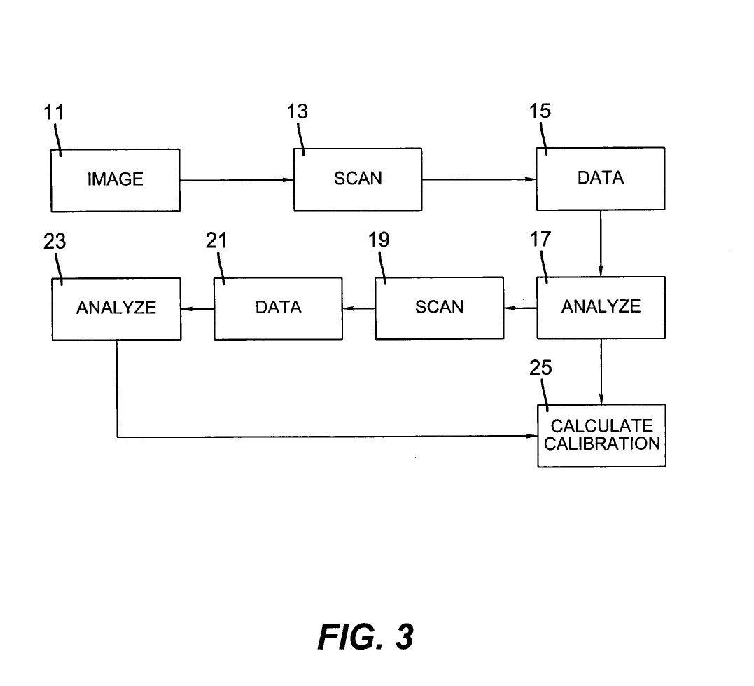

FIG. 3 shows the steps of the embodiments described herein. The embodiments described herein generally include a method of calibrating a printing system. The method includes imaging 11 a test pattern 10. The test pattern 10 includes a set of densities. Each density is based on a plurality of exposures which have been randomized thereby forming an imaged test pattern.

The method further includes scanning 13 the densities of the imaged test pattern thereby forming a dataset 15. In one embodiment, the density of the test pattern is made from a thermal dye donor. In another embodiment, the density of the test pattern comprises multiple colors.

Then, the method includes analyzing 17 the dataset 15 to identify outlier data. If outlier data is identified, then the test pattern 10 undergoes a second scan 19, a second dataset is formed 21 and the second dataset is analyzed 23 for outlier data. If no outlier data is identified, a first density point 28 and a second density point 30 of the dataset are computed 25 to form an array 36a, 36b, 36c of exposures versus a density between the first and second density points, thereby forming a polynomial calibration curve 38 from the array of exposures and the density array. For example, the first density point can be a toe point. The second density point can be a shoulder point. Alternatively, the second density point can be a desired density point for setting a maximum for a polynomial calibration curve, as described below.

The method then includes calibrating 25 an adjustable density printing system using the polynomial calibration curve.

In one embodiment, the method further includes calculating for a threshold of the density data to obtain the toe density point. In another embodiment, the method includes laminating the test pattern onto a paper stock.

In one embodiment, the imaged test pattern is formed by a printing system comprising a printer, a laminator, a spectrometer or combinations thereof. In yet another embodiment, the printing system is a laser thermal, silver halide, or an inkjet printer. In yet another embodiment, the printing system is a digital printer. In yet another embodiment, the printing system comprises a laser printer.

In another embodiment, the method further includes removing data outside of three standard deviations from the polynomial calibration curve.

The method can further include after forming a polynomial calibration curve 38 from the array of exposures and the density array, computing a first slope for density greater than the second density point.

Alternatively, the method can include after forming a polynomial calibration curve 38 from the array of exposures and the density array, computing a second slope for density less than the first density point.

In one embodiment, the first and second slopes are extensions of the polynomial calibration curve therein adapting the curve to be usable for extreme density ranges.

In another embodiment, the method includes subtracting paper density from the dataset enabling the calibration curve to be insensitive to the type of paper stock used in the printing system.

In yet another embodiment, the test pattern 10 includes an independent row 200 for each set of densities 90, 91, 92, 93 and at least four points within a row 300, 302, 304, 306 that include only paper density.

Calibration Target or Test Pattern

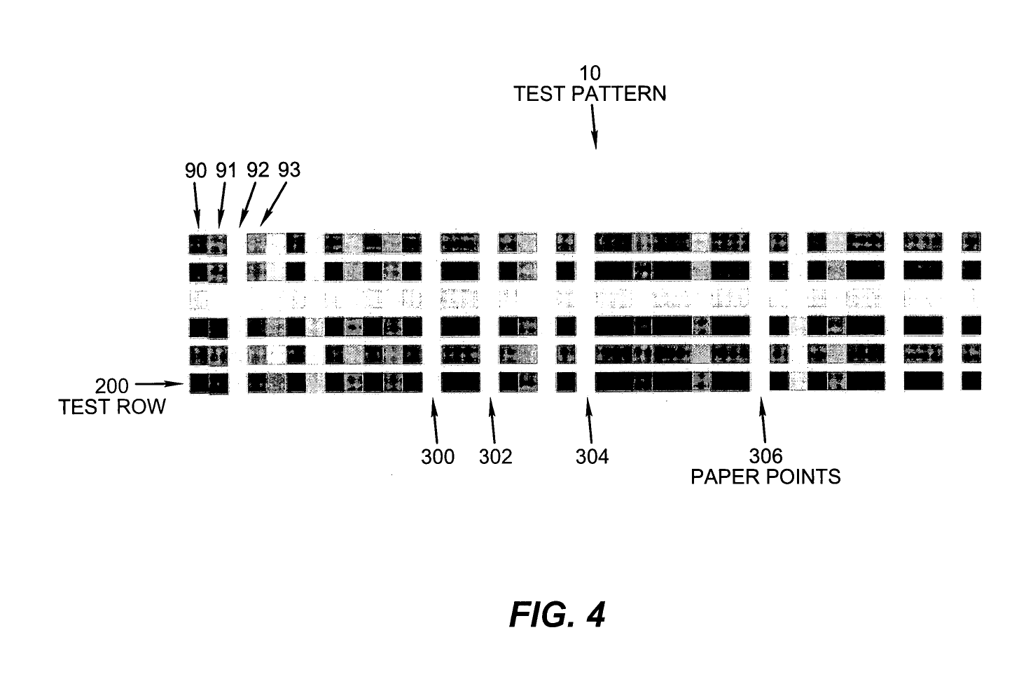

FIG. 4 shows a test pattern 10 which is used to measure the output density for a requested exposure. The test pattern preferably includes forty-one sets of density 90, 91, 92, 93. Up to six colors can be included on the test pattern. A separate row 200 with a unique exposure array per row is used for each thermal dye donor when imaging multiple thermal dye donors on a single calibration target. The patches 40 are arranged in the slow scan direction of the proofer in order to capture the majority of the density variability. Orientating the sets of density data in the direction of the largest noise source is generally necessary to provide an accurate average density response. The number of sets of density patches per row has been maximized in order to generate accuracy in the presence of density noise. The order of the exposures has been randomized to provide stability of the calibration model in the presence of density noise. The order of the sets of density also allows for a minimum patch to patch contrast of 0.5 density, which is required to use a scanning spectrophotometer model number DTP-41 manufactured by X-Rite. Forty-one exposures have been predetermined for each donor based on desired calibration accuracy, thermal media variability, and machine variability. Exposure step rates are not consistent; there exists a smaller exposure step rate at low exposures levels to provide the most accurate low density response. At higher exposure levels, the exposure step rate increases. Very high exposures are added to accommodate machine drift. Four paper points 300, 302, 304, 306 are placed in the calibration target for accurate measurement of the paper stock. The model subtracts the paper density off the measured density to allow for consistent density output across different paper stocks.

Density Processing

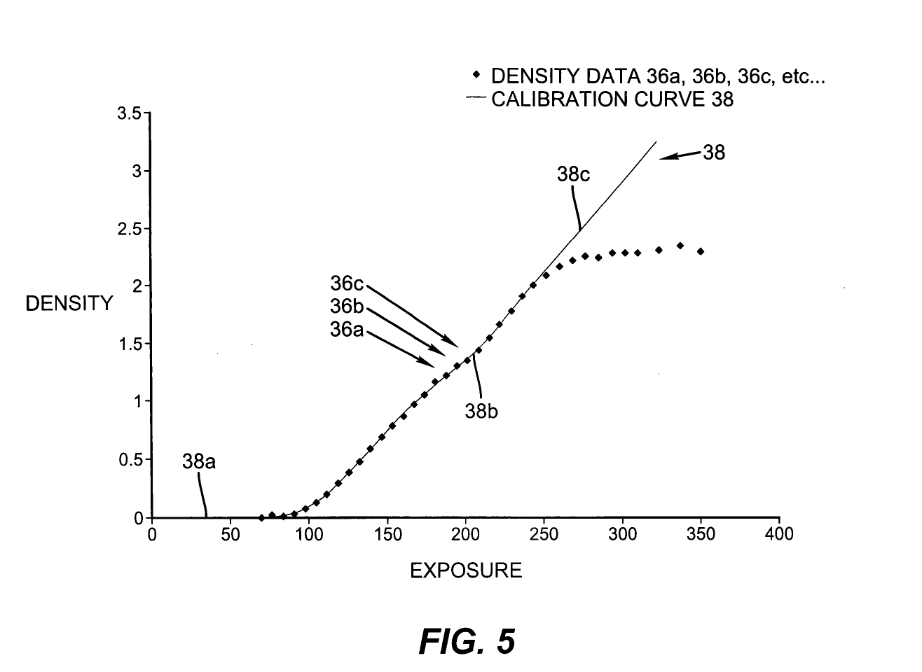

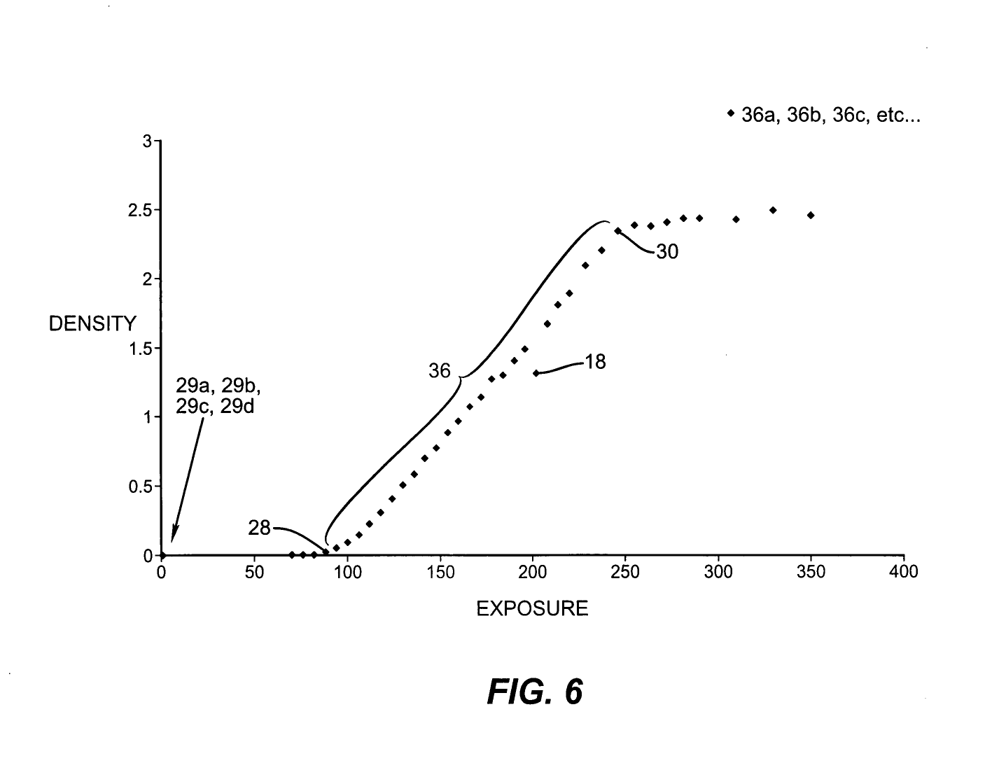

The test pattern 10 is scanned in using a X_Rite DTP41 spectrophotometer and a custom graphical user interface to allow for density viewing, saving and processing. The results of the density processing can be seen in FIGS. 5 and 6.

The first step in generating a calibration curve 38 is to remove the paper density from the measured density array made of density values 36a, 36b, 36c. The four paper points 300, 302, 304, 306 are averaged to provide greater statistical accuracy. Removing the paper density allows for consistent calibration using various types of paper.

The density 36 is checked for the scanning direction of the calibration target or test image. It is possible to scan the target in either direction, therefore, to avoid user introduced errors, the densities are checked for correct order.

The entered densities 36a, 36b, 36c are then error checked using the correlation coefficient of an 8^{th} degree polynomial fit to the measured density at different exposure request data. This check is to ensure that the entered density data will provide a reasonable model. Spectrophotometer scanning errors and other erroneous data can be caught using this technique and the test image will be required to be re-measure. The entered densities are then checked for outlier data points using the following technique.

A data point is removed from the measured density and exposure arrays. An eight degree polynomial is fit to the remaining measured density and exposure data. A check is performed to determine if the removed data point lies within +/− three standard deviations from the calculated polynomial. The check is then repeated for the remaining density and exposure data points, as shown in FIG. 6. Points exceeding +/− three standard deviations 18 from the calculated polynomial curve are removed.

FIG. 6 shows in detail the next step in calculating a calibration curve. The next step is to determine where the first density point 28 or toe exposure 38a and the second density point 30 or shoulder exposure 38c exist. The toe exposure point is the lowest exposure required to produce a density higher than paper density 29a, 29b, 29c, 29d. The shoulder exposure 38c is the lowest exposure where the maximum density output a thermal dye donor is produced. By evaluating the derivative of density with respect to exposure the rate of change can be determined. A three point moving average is performed on the derivative of density to provide greater statistical accuracy determining the toe exposure and the shoulder exposure. An experimentally calculated threshold is used to locate the toe exposure and the shoulder exposure. Due to thermal donor differences the threshold values are unique to each thermal dye donor.

The determination of the toe exposure and the shoulder exposure are critical for controlling an eight degree polynomial 38b. The polynomial 38b is well behaved when using density and exposure data 36a, 36b, 36c between the toe exposure and the shoulder exposure. Including density and exposure data before the toe exposure and after the shoulder exposure will limit the accuracy of the polynomial 38b in the area between the toe exposure and the shoulder exposure as well as provide unpredictable results before 38a the toe exposure and after the shoulder exposure 38c.

Several thermal dye donors are capable of producing more density than is required. For these thermal donors the polynomial fit is calculated between the toe exposure and the exposure required for the maximum desired density. Limiting the density range for calculation of a polynomial 38b allows for increased accuracy for densities between the toe exposure and the maximum required density.

Densities above the shoulder exposure or the maximum desired density are modeled using a straight line or first slope fit 38c to the one valid data point below the shoulder exposure or maximum desired density as well as the shoulder exposure or the exposure for maximum desired density. The post-shoulder slope 38c is used to guarantee an increase in exposure will occur for an increased density request.

Densities below the toe exposure are modeled using a second slope 38a fit to the toe exposure and toe density and the paper exposure and paper density.

The calibration curve 38 is calculated by providing a list of desired densities. From the calculated polynomial 38b, the pre-toe slope 38a, and the post-shoulder slope 38c, the exposures are determined for each density request. The calibration contents are then used as a look up table during imaging.

Optimizing Exposures

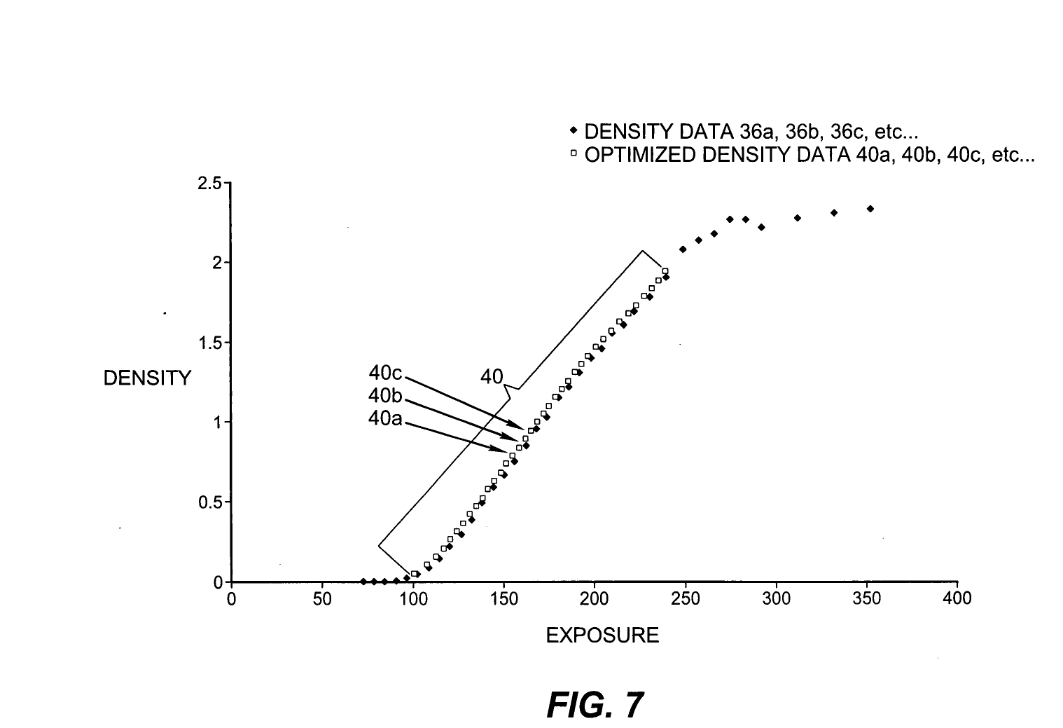

FIG. 7 show the results of optimizing exposures to produce a calibration target with desired density values 40. Using the calibration curve 38 for a given thermal donor and a given set of density requests 40 for the corresponding thermal donor, the exposures for the calibration target can be calculated using linear interpolation. This is achieved by selecting exposure values for the density points 36a, 36b, 36c, etc, that are just higher and lower than the optimized density request 40a, 40b, 40c, etc. Linear interpolation is then used on the set of density and exposure data points and the density request 40a, 40b, 40c to calculate the exposure at the given optimized density request 40a, 40b, 40c, etc. For the lowest and highest optimized density request 40a, 40b, 40c, etc, linear extrapolation is used based on the two previous density points 36a, 36b, 36c, etc, and corresponding exposure data points.

Exposure Adjustment Calibration Process

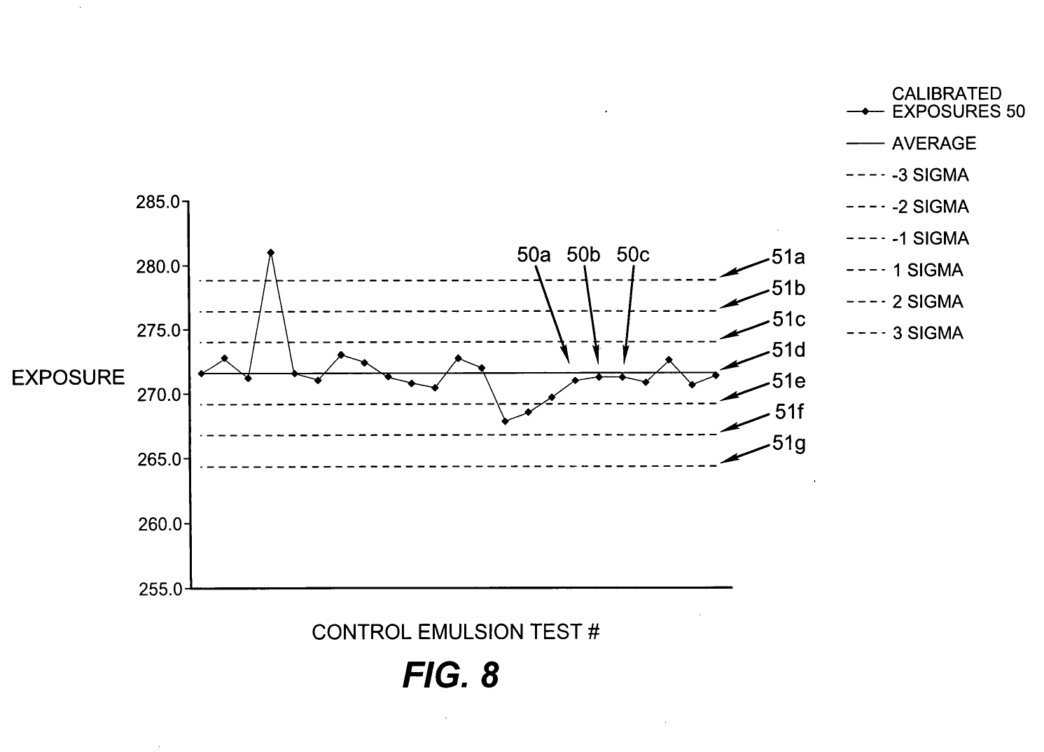

Referring to FIG. 8, there is an example of a control chart for tracking the calibration performance of an imaging device for a similar set of thermal media and thermal receiver. Calibrated exposures 50a, 50b, 50c, etc, are plotted for a single density request using a calibration curve 38 for similar emulsions imaged at different points in time. The average exposure 51d for a density request is calculated along with the −3, −2, −1, 2 and 3 standard deviation differences from the average exposure 51a, 51b, 51c, 51e, 51f, 51g. The imaging device is considered in control if the following criteria are met: No single exposure exists beyond 3 standard deviation unit distance from an average exposure line, no 2 out of 3 exposures exist on the same side of an average exposure line and more than 2 standard deviation units beyond the average exposure line, no 4 out of 5 exposures exist on the same side of an average exposure line and more than 1 standard deviation unit beyond the average exposure line, no 8 out of 9 points on the same side of an average exposure line. If the stated specifications are violated then the control imaging device will require servicing.

Inevitably a control thermal donor set will run out and require replacement. Acceptable alternate thermal donors and thermal receivers can be located by evaluating their calibrated exposure performance. Thermal media and thermal receiver emulsions that test within 1 sigma of the average exposure are good candidates for using as a new control material.

Due to loss of efficiency the control imaging device will exhibit exposure drift over time and therefore require servicing, however the control imaging device exposure stability may not be guaranteed after servicing.

When attempting to calibrate thermal donors on a control imaging device and exporting the calibration such that a remote imaging device can use the calibration data to bypass performing calibration on the lot of thermal donor, the stability of the control imaging device becomes critical. As discussed the control imaging device will exhibit drift over time. Media lots calibrated at a significantly different time will therefore inherit drift due to machine drift. A remote machine may image two lots that were characterized at different points in time possibly causing a change in performance. No guarantee can be placed on the order of distribution of media therefore the control imaging device exposures must remain constant if exposures are to be exported to remote imaging devices.

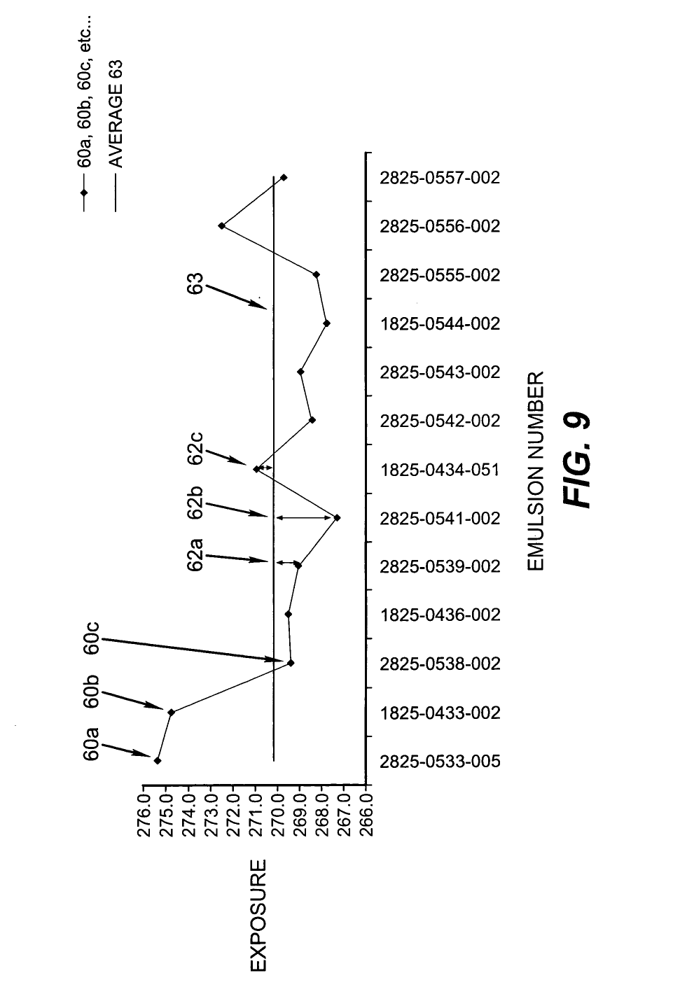

FIG. 9 shows a method for dealing with control imaging device exposure drift over time. Thermal media emulsions 60a, 60b, 60c, etc are calibrated on a control imaging device with a control thermal receiver. Calibrated exposures for specified density levels for thermal media emulsions and control thermal receiver 60a, 60b, 60c, etc are compared to the average calibrated exposure for specified density levels of thermal media emulsions 63 and control thermal receiver to produce exposure adjustment points 62a, 62b, 62c, etc for each thermal media emulsion. Exposure adjustment points 62a, 62b, 62c, etc, can be calculated using a moving average for relatively small sample sizes to decouple control imaging device exposure drift from thermal media and thermal receiver calibrated exposures.

Exposure adjustment points 62a, 62b, 62c, etc, can be calculated similarly for a thermal receiver. Each thermal receiver is measured using a control thermal media and a control imaging device. Calibrated exposures for specified density levels for control thermal media and test thermal receiver emulsions 60a, 60b, 60c, etc are compared to the average calibrated exposure for specified density levels of control thermal media and test thermal receiver emulsions 63 to produce exposure adjustment points 62a, 62b, 62c, etc for each thermal receiver emulsion. Exposure adjustment points 62a, 62b, 62c, etc, can be calculated using a moving average for relatively small sample sizes to decouple control imaging device exposure drift from thermal media and thermal receiver calibrated exposures.

Exposure adjustment points 62a, 62b, 62c, etc, can be calculated at many different density levels. Each thermal media can exhibit different areas of stability. The exposure adjustment points can be used for multiple density levels to quantify the amount of change in exposure for different density ranges for an individual lot of thermal media.

Exposure adjustment points 62a, 62b, 62c, etc, or other calibration data can be made available for export to remote locations through internet distribution, hardcopy mail distribution, or coded into an radio frequency ID tag associated with a roll of thermal media.

Exposure adjustment points 62a, 62b, 62c, etc, can have their values limited by a predetermined amount to limit the effects of density and exposure noise.

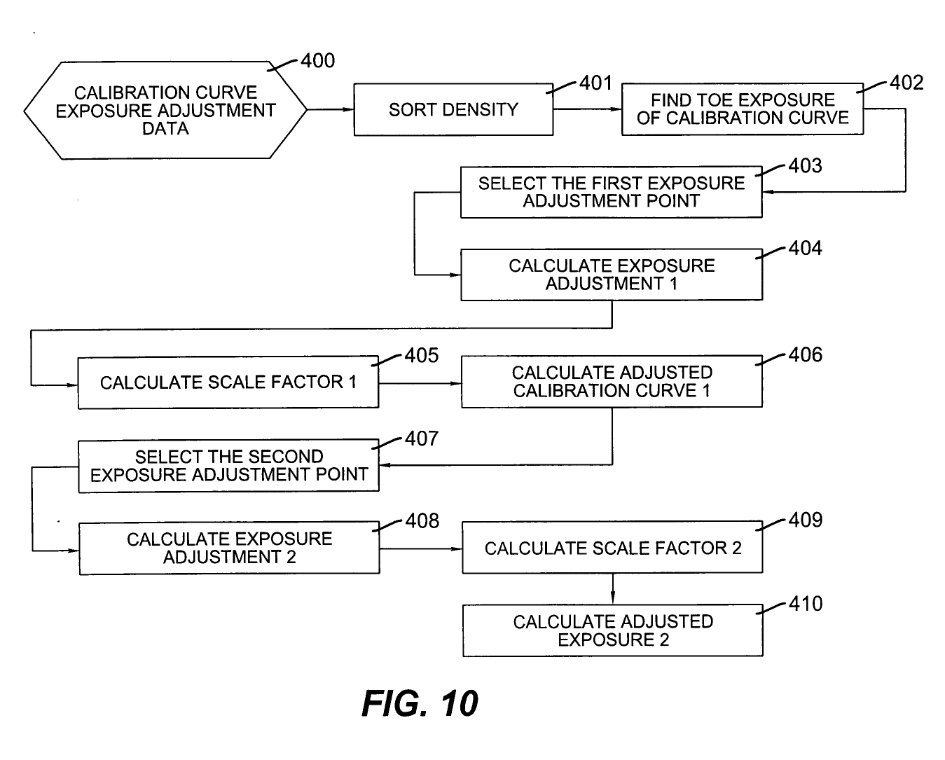

A remote imaging device can use exposure adjustment points 62a, 62b, 62c, etc, along with an existing exposure calibration curve 38 to calculate a new exposure calibration curve 38. FIG. 10 describes the process to calculate a new exposure calibration curve 38. The process requires an initial exposure calibration 38 using a lot of thermal media and thermal receiver, the exposure adjustment values 62a, 62b, 62c, etc, associated with thermal media and thermal receiver used for the initial calibration, and the exposure adjustment values 62a, 62b, 62c, etc for a set of thermal media and thermal receiver which requires calibration. As a user loads a new set of thermal media and thermal receiver the host software will collect the associated exposure adjustment values 62a, 62b, 62c, etc. The exposure calibration curve 38 must be sorted by density level 401. The toe exposure can then be selected from the calibration curve 402. The exposure adjustment values 62a, 62b, 62c, etc. for thermal media and thermal receiver for the lowest density are selected 403. A first exposure adjustment 404 is calculated for specified density levels by adding adjustment values 403 for the initial thermal media to the exposure adjustment value 62a, 62b, 62c, etc, for the initial thermal receiver, then the exposure adjustment 62a, 62b, 62c, etc, for the new thermal media and the exposure adjustment 62a, 62b, 62c, etc, for the new thermal receiver are subtracted.

The equation to calculate the exposure adjustment 404 can be seen below:
Exposure Adjustment 1=Thermal Media Exposure Adjustment 1 Control Imaging Device+Thermal Control Exposure Adjustment 1 Remote Imaging Device−Thermal Media Exposure Adjustment 1 Remote Imaging Device−Thermal Media Receiver Exposure Adjustment 1 Remote Imaging Device

The exposure adjustment points 404 are used to pivot a polynomial curve. There can be many defined pivot points for different types of thermal media. The toe exposure 402 is often used as a first pivot point. To pivot the polynomial calibration curve 38, 400, a first scale factor is required. A first scale factor 405 is calculated as follows:
Scale Factor 1=(OriginalExposure(Density Request 1)−ToeExposure)/( OriginalExposure(Density Request 1)+Exposure Adjustment 1−ToeExposure)
where Original exposure refers to the initial calibration curve 38, 400 and density request 1 refers to the density level of the first exposure adjustment point 403.

The scale factor is applied from the toe density 402 to the maximum calibration density to the initial calibration curve 38, 400 to calculate a set of adjusted exposure values 406 as follows:
AdjustedExposure1(Density Request)=(OriginalExposure(Density Request)−Toe Exposure)*Scale Factor 1+Toe Exposure
where Original exposure refers to the initial calibration curve 38, 400 and density request refers to the density levels to be calibrated. Typically calibrated density levels range from paper density to the maximum obtainable density by the imaging device.

The process can be extended to include a more than one exposure adjustment point. The polynomial calibration curve 406 will use the first exposure adjustment point 403 as a starting pivot point and a second exposure adjustment point 407 will be used to pivot the polynomial calibration curve 406. The second calibration curve exposure adjustment point 408 can be obtained through the following equation:
Exposure Adjustment 2=Thermal Media Exposure Adjustment 2 Control Imaging Device+Thermal Control Exposure Adjustment 2 Remote Imaging Device−Thermal Media Exposure Adjustment 2 Remote Imaging Device−Thermal Media Receiver Exposure Adjustment 2 Remote Imaging Device
The scale factor for exposure adjustment 2 409 is then needed to pivot the curve and is calculated as follows:
Scale Factor2=(AdjustedExposure1(Density Request 2)−AdjustedExposure1(Density Request 1)/(AdjustedExposure1(Density Request 2)−[OriginalExposure(Density Request 2) +Exposure Adjustment 2−AdjustedExposure1(Density Request 2)]−AdjustedExposure1(Density Request 1))
Where AdjustedExposure1 is the first adjusted calibration curve 406 and density request 2 refers to the density level of the second exposure adjustment point 407.

The scale factor is applied from the density of the first exposure adjustment point 403 to the maximum calibration density to the first adjusted calibration curve 406 to calculate a second set of adjusted exposure curve 410 as follows:
AdjustedExposure2(Drequest)=(AdjustedExposure1(Density Request)−AdjustedExposure1(Density Request 1))*Scale Factor 2−AdjustedExposure1(Density Request 1)
The process can be extended to include multiple exposure adjustment points.
Calibration Averaging

Thermal media contains variability in sensitometric performance lot to lot. The manufacturing variability is typically large enough to require exposure calibration for each lot of thermal media and thermal receiver. Exposure calibration also exhibits variability that is typically less than the thermal media manufacturing variability.

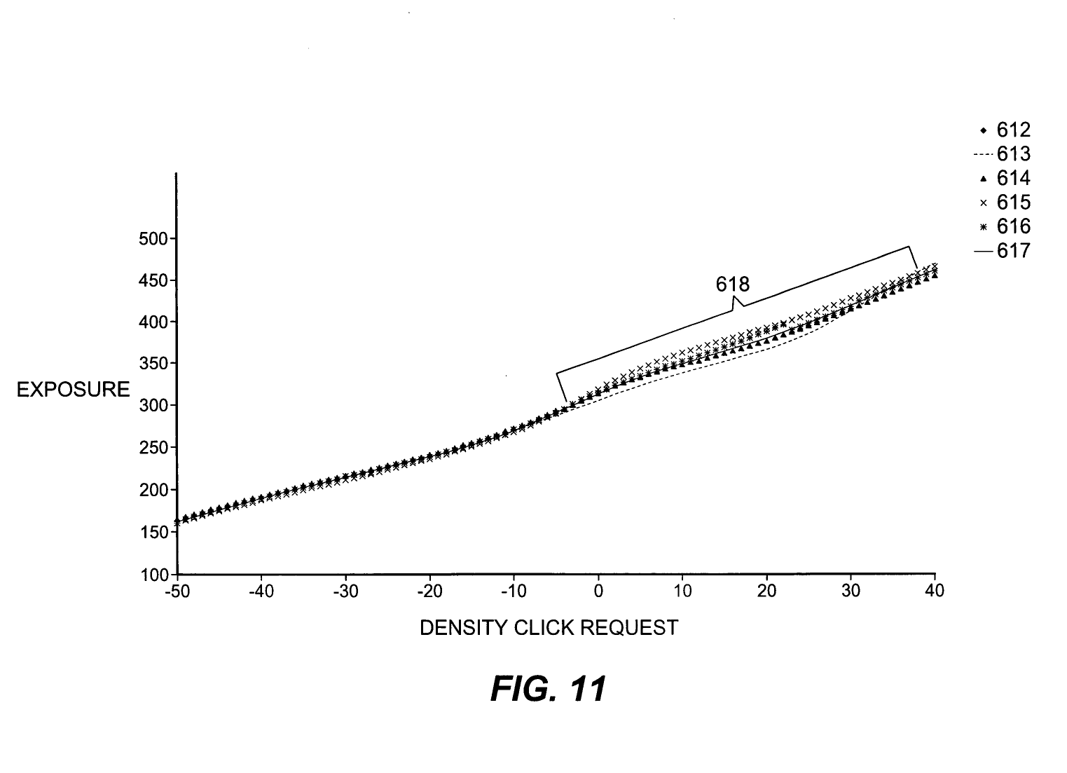

FIG. 11 shows a method to reduce the density variability due to variability of sensitometric performance lot to lot for thermal media by averaging multiple exposure calibrations 612, 613, 614, 615, 616 of various or individual thermal media lots. Averaging multiple exposure calibrations of individual thermal media lots will increase the amount of data available to build a density and exposure model and may improve calibration accuracy. Averaging multiple exposure calibrations for different thermal media lots will produce an exposure calibration 617 designed for an average thermal media sensitometric performance. Using an average exposure curve 617 will reduce the range of density error due to thermal media lot to lot sensitometric differences. The variability of density accuracy for an average exposure calibration curve 617 will typically be similar to the variability obtained when using unique exposure calibrations 612, 613, 614, 615, 616 for individual thermal media lots. The variability of density accuracy for an average exposure calibration curve 617 can be larger if an outlier thermal media lot is used for the calculation of an average exposure calibration curve 617 or if an outlier thermal media is imaged using an average exposure calibration curve.

Averaging can be used in conjunction with the exposure adjustment calibration calculation described in FIG. 10. Multiple exposure calibration curves 400, 612, 613, 614, 615, 616 can be averaged along with associated exposure adjustment points 62a, 62b, 62c, etc. The equation to calculate the exposure adjustment 404 for average thermal media can be seen below:
Exposure Adjustment 1=Thermal Media Exposure Adjustment 1 Control Imaging Device+Average Thermal Control Exposure Adjustment 1 Remote Imaging Device−Thermal Media Exposure Adjustment 1 Remote Imaging Device−Average Thermal Media Receiver Exposure Adjustment 1 Remote Imaging Device
The first scale factor 405 for average thermal is calculated as follows:
Scale Factor 1=(OriginalExposure(Density Request 1)−Average ToeExposure)/(OriginalExposure(Density Request 1)+Exposure Adjustment 1−Average ToeExposure)
where Original exposure refers to the average calibration curve 617 and density request 1 refers to the density level of the first exposure adjustment point 403.

The scale factor is applied from the toe density 402 to the maximum calibration density to the average calibration curve 617 to calculate a set of adjusted exposure values 406 as follows:
AdjustedExposure1(Density Request)=(OriginalExposure(Density Request)−Toe Exposure)*Scale Factor 1+Toe Exposure
where Original exposure refers to the average calibration curve 617 and density request refers to the density levels to be calibrated.

The second average calibration curve 617 exposure adjustment point 408 can be obtained through the following equation:
Exposure Adjustment 2=Thermal Media Exposure Adjustment 2 Control Imaging Device+Thermal Control Exposure Adjustment 2 Remote Imaging Device−Average Thermal Media Exposure Adjustment 2 Remote Imaging Device−Average Thermal Media Receiver Exposure Adjustment 2 Remote Imaging Device
The scale factor for exposure adjustment 2 409 is then needed to pivot the average exposure calibration curve 617 and is calculated as follows:
Scale Factor 2=(AdjustedExposure1(Density Request 2)−AdjustedExposure1(Density Request 1)/(AdjustedExposure1(Density Request 2)−[OriginalExposure(Density Request 2) +Exposure Adjustment 2−AdjustedExposure1(Density Request 2)]−AdjustedExposure1(Density Request 1))
where AdjustedExposure1 is the first adjusted calibration curve 406 and density request 2 refers to the density level of the second exposure adjustment point 407.

The scale factor is applied from the density of the first exposure adjustment point 403 to the maximum calibration density to the first adjusted calibration curve 406 to calculate a second set of adjusted exposure curve 410 as follows:
AdjustedExposure2(Drequest)=(AdjustedExposure1(Density Request)−AdjustedExposure1(Density Request 1))*Scale Factor 2−AdjustedExposure1(Density Request 1)
The process can be extended to include multiple exposure adjustment points.

An advantage of using averaging for exposure calibration curves in combination with exposure adjustments is that outlier thermal media sensitometric curves will be characterized and compensated when calculating and adjusting the average calibration curve 617. The manufacturing process for thermal media is therefore allowed to vary which in turn will reduce waste.

An advantage of averaging exposure calibration curves is the amount of data used in correlating a control imaging device and a remote imaging device is increased resulting in an increase in accuracy.

An advantage of averaging exposure calibration curves is to increase repeatability in noisy density areas 618. By averaging exposure calibration curves the imaging device will reduce the range of density error.

The invention has been described in detail with particular reference to certain preferred embodiments thereof, but it will be understood that variations and modifications can be effected within the scope of the invention.

### PARTS LIST

10 test pattern
11 test pattern
13 first density scan
15 first dataset
17 density analysis
18 standard deviation
19 second density scan
21 second dataset
23 density analysis
25 calibration calculation
28 first density point
29a paper density
29b paper density
29c paper density
29d paper density
30 second density point
36 density
38 calibration curve
36a density
36b density
36c density
38a toe exposure
38b polynomial
38c shoulder exposure
40 set of density
40a density request
40b density request
40c density request
50a a calibrated exposure
50b calibrated exposure
50c calibrated exposure
51a control limit
51b control limit
51c control limit
51d control limit
51e control limit
51f control limit
51g control limit
60a calibrated exposure
60b calibrated exposure
60c calibrated exposure
62a exposure adjustment
62b exposure adjustment
62c exposure adjustment
63 thermal media emulsions
90 sets of density
91 sets of density
92 sets of density
93 sets of density
112 image processor housing
114 image processor door
115 media drive mechanism
116 media carousel
118a donor material
118b roll media
118c roll media
118d roll media
118e roll media
118f roll media
118g thermal print media
120 laser assembly
122 laser diodes
124 fiber optic cables
126 distribution block
128 printhead
130 vacuum imaging drum
132 donor ejection chute
134 donor waste bin
136 transport mechanism
137 exit tray
140 drive roller
142 drive roller
144 media knife assembly
146 drum load roller
148 translation bearing rods
150 translation bearing rods
152 lead screw
154 lathe bed scanning frame
156 lead screw drive nut
158 movable translation stage member
200 separate row
300 paper point
302 paper point
304 paper point
306 paper point
400 calibration curve
401 density level
402 find toe exposure
403 select first exposure adjustment point
404 calculate exposure adjustment 1
405 calculate scale factor 1
406 calculate adjusted calibration curve 1
407 select second exposure adjustment point
408 calculate exposure adjustment 2
409 calculate scale factor 2
410 calculate adjusted exposure 2
612 calibration curve
613 exposure calibration curve
614 exposure calibration curve
615 exposure calibration curve
615 exposure calibration curve
616 exposure calibration curve
617 exposure calibration curve
618 noise density area

1. A method of calibrating a printing system comprising:
stabilizing a control image processing apparatus;
plotting data points at a first exposure level for printing to control media on said control image processing apparatus;
measuring a drift for said first exposure level for said control image processing apparatus over time;
adjusting said first exposure level for said control image processing apparatus if said data points are outside of a predetermined range;
preparing a curve of exposure level versus density for a plurality of shipped media;
calculating an average exposure level for said plurality of shipped media;
calculating a difference between said average exposure level and a second exposure level for each of said shipped media; and
transmitting said difference for each of said shipped media to a customer.

2. A method as in claim 1 wherein said difference is transmitted to said customer by means of a radio frequency identification (RFID) tag attached to said particular media.

3. A method as in claim 1 wherein said difference is transmitted to said customer electronically.

4. A method as in claim 1 additional step comprising:
imaging a target on a first shipped media on said customer image processing apparatus to create a first image;
scanning said first image of said target into host software on said customer image processing apparatus;
calculating a first calibration curve of exposure versus density;
imaging said target on a second shipped media on said customer image processing apparatus to create a second image;
scanning said second image of said target into host software on said customer image processing apparatus;
calculating a second calibration curve of exposure versus density;
averaging said first and second calibration curves;
averaging a first difference for said first shipped media with a second difference for said second to shipped media;
loading a third shipped media on said customer image processing apparatus;
calculating an adjustment point by adding said average difference to a third difference for said third shipped media; and
adjusting said average of said first and second calibration curves of exposure versus density on said customer image processing apparatus based on said adjustment point.

5. A method as in claim 4 wherein:
said average difference is based on a plurality of differences for a plurality of shipped media; and
said average of said calibration curves are based on a plurality of calibration curves of exposure versus density.

6. A method of calibrating a printing system comprising:
stabilizing a control image processing apparatus;
plotting data points at an first exposure level for printing to control media on said control image processing apparatus;
measuring a drift for said first exposure level for said control image processing apparatus over time;
adjusting said first exposure level for said control image processing apparatus if said data points are outside of a predetermined range;
preparing a curve of exposure level versus density for a plurality of shipped media;
calculating an average exposure level for said plurality of shipped media;
calculating a difference between said average exposure level and a second exposure level for each of said shipped media;
transmitting said difference for each of said shipped media to a customer;
imaging a target on a first shipped media on said customer image processing apparatus to create a first image;
scanning said first image of said target into host software on said customer image processing apparatus;
calculating a first calibration curve of exposure versus density;
imaging said target on a second shipped media on said customer image processing apparatus to create a second image;
scanning said second image of said target into host software on said customer image processing apparatus;
calculating a second calibration curve of exposure versus density;
averaging said first and second calibration curves;
averaging a first difference for said first shipped media with a second difference for said second to shipped media;
loading a third shipped media on said customer image processing apparatus;
calculating an adjustment point by adding said average difference to a third difference for said third shipped media; and
adjusting said average of said first and second calibration curves of exposure versus density on said customer image processing apparatus based on said adjustment point.

7. A method of calibrating a printing system comprising:
preparing a curve of exposure level versus density for a plurality of shipped media;
calculating an average exposure level for said plurality of shipped media;
calculating a difference between said average exposure level and a second exposure level for each of said shipped media; and
transmitting said difference for each of said shipped media to a customer.
